(19) United States
(12) Patent Application Publication
(10) Pub. No.: US 2021/0061024 A1
(43) Pub. Date: Mar. 4, 2021

(54) TIRE WITH NO BEAD TURNUP

(71) Applicant: The Goodyear Tire & Rubber Company, Akron, OH (US)

(72) Inventors: Gilles Bonnet, Niederfenlen (LU); Olivier Di Prizio, Hettange-Grande (FR); Ralph Damon Ring, Beach City, OH (US); Gilles Reichling, Vichten (LU); Nicolas Soultis, Freylange (BE); Robert Edward Lionetti, Bereldange (LU); Patrice Jacques Omont, Hobscheid (LU); William Alain Francis Ghislain Talbot, Bastogne (BE)

(21) Appl. No.: 16/939,578

(22) Filed: Jul. 27, 2020

Related U.S. Application Data
(60) Provisional application No. 62/893,429, filed on Aug. 29, 2019.

(51) Int. Cl. B60C 15/00; B60C 15/06

(52) U.S. Cl. CPC B60C 15/0018; B60C 15/06

(57) ABSTRACT

A tire having no ply turnup is described. The tire includes a tread, a single layer of ply, a first triangular shaped bead and a second triangular shaped bead, wherein the radially inner end of the single layer of ply is secured between the first bead and the second bead.

### FIELD OF THE INVENTION

The invention relates generally to tires and more particularly to a pneumatic tire.

### BACKGROUND OF THE INVENTION

For high performance and ultra-high performance tires, it is often desired to eliminate the ply turnup around the bead. Eliminating the ply turnup removes the stress concentration and improves the ply line in the lower area of the tire. Further, if the bead has no ply turnup, there is increased design flexibility for tire/rim interface improvement. However, it is difficult to build the tire without building the tire on a solid core. The ply cord typically pulls out from the bead during the tire curing process, because of the rapid expansion of the tire carcass during the cure process. The solid core eliminates the movement of the carcass. However, building a tire on a solid core requires special equipment and often is a much slower tire building process. Thus, it is desired to provide a tire that has no ply turnup using conventional tire building equipment.

### Definitions

“Aspect ratio” of the tire means the ratio of its section height (SH) to its segment width (SW) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tangent delta”, or “tan delta,” is a ratio of the shear loss modulus, also known as G″, to the shear storage modulus (G′). These properties, namely the G′, G″ and tan delta, characterize the viscoelastic response of a rubber test sample to a tensile deformation at a fixed frequency and temperature, measured at 100° C.

“Tread element” or “traction element” means a rib or a block element defined by a shape with adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a cross-sectional view of a tire with no bead turnup;

FIG. 2 is a close-up view of the bead area of the tire of FIG. 1;

FIG. 3a is a close-up view of the first bead of the tire of FIG. 1; and

FIG. 3b is a close-up view of the second bead of the tire of FIG. 1.

### DETAILED DESCRIPTION OF THE PRESENT INVENTION

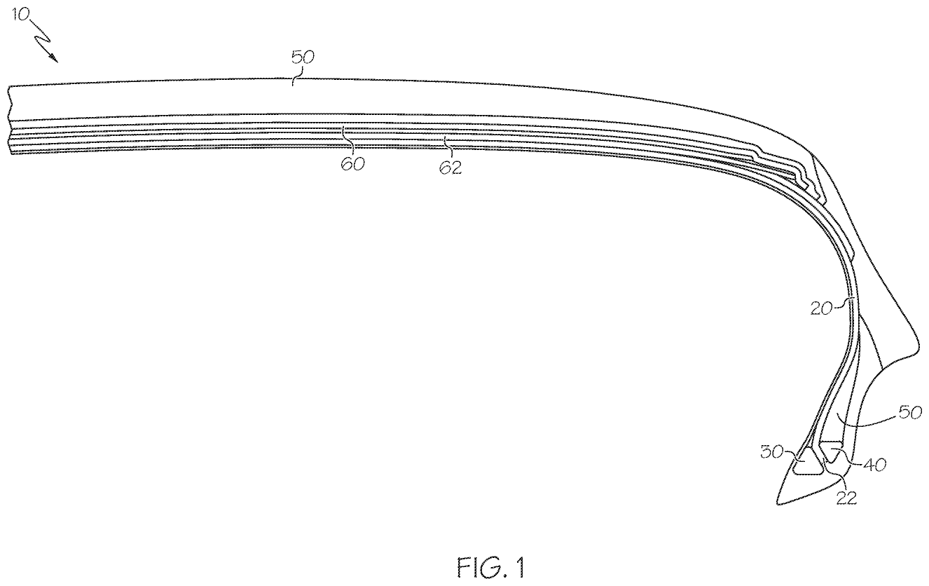

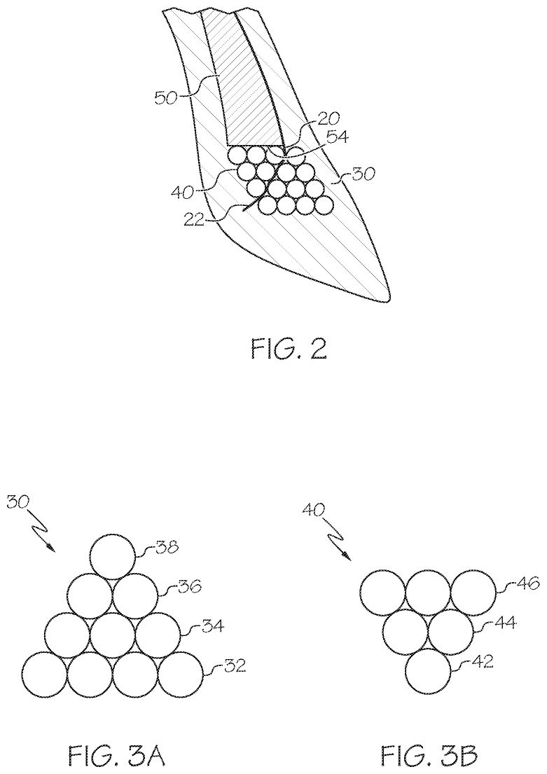

FIG. 1 illustrates a tire 10 of the present invention that has no bead turnup. The tire 10 may further include a tread 50, and belts 60,62. The belts 60,62 may comprise conventional belt configurations known to those skilled in the art.

The tire 10 has a single layer or monolayer of ply 20, that has a radially inner portion 22 that is clamped between a first bead 30 and a second bead 40. The ply layer 20 is comprised of radial cords that may be formed of a high modulus 2200/3 denier cords or 3340/2 denier cords. The cord material may be nylon, aramid, or a hybrid construction of nylon/aramid. The lower ply end 22 is clamped between the first bead 30 and the second bead 40. The first bead 30 is a triangular shaped bead formed of a plurality of bead wires that are formed into a pyramid. As shown in FIG. 3A, the first bead 30 has four rows of reinforcement wires, with four reinforcement wires in the radially inner most layer 32, three reinforcement wires in the third layer 34, two reinforcement wires in the second layer, and one reinforcement wire in the radially outermost or first layer 38. The first bead 30 is formed of metal wire, preferably a 1.3 mm wire, or with a diameter ranging from 0.8 to 1.5 mm. The first bead 30 may be pre-formed and then applied onto the tire building drum.

The tire further includes a second or axially outer bead 40 that functions to clamp the ply ending 22 between the first and second beads 30,40. The axially outer bead 40 is an inverted triangle, and has at least two layers of reinforcement wires. Like the first bead, the second bead is formed of metal wire, preferably a 1.3 mm wire, or with a diameter ranging from 0.8 to 1.5 mm. The first layer 42 is the radially inward layer formed of a single reinforcement wire, while the middle layer 44 is formed of two reinforcement wires. The radially outermost layer 46 is formed of three reinforcement wires.

The tire may further include an optional apex 50 that is located radially outward of the axially outer bead 40. The second apex has a radially outer portion 52 that is triangular, and is located between the ply 20 and the chafer 24. The second apex 50 has a radially inner lip 54 that is positioned adjacent the axially outer bead 40. The second apex 50 is formed from a highly stiff material in order to get a stiffness gradient between the bead wire and the chafer compound. The second apex is mechanically locked to the second bead and the surrounding area, minimizing or eliminating the ply slippage during the tire building process and shaping process. The stiffness may be characterized by the dynamic modulus G′, which are sometimes referred to as the “shear storage modulus” or “dynamic modulus,” reference may be made to Science and Technology of Rubber, second edition, 1994, Academic Press, San Diego, Calif., edited by James E. Mark et al, pages 249-254. The shear storage modulus (G′) values are indicative of rubber compound stiffness which can relate to tire performance. The tan delta value at 100° C. is considered as being indicative of hysteresis, or heat loss.

In a first embodiment, the second apex 50 comprises a stiff rubber composition having a shear storage modulus G′ measured at 1% strain and 100° C. according to ASTM D5289 ranging from 14 to 43 MPa, In a more preferred embodiment, the second apex 50 comprises a rubber composition having a shear storage modulus G′ measured at 1% strain and 100° C. according to ASTM D5289 ranging from 23 to 43 MPa.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire having no ply turnup, the tire comprising a tread, a single layer of ply, a first triangular shaped bead and a second triangular shaped bead, wherein the radially inner end of the single layer of ply is secured between the first bead and the second bead.

2. The tire of claim 1 wherein the first triangular shaped bead is formed of two or more layers of reinforcement wires.

3. The tire of claim 1 wherein the first triangular shaped bead is formed of three or more layers of reinforcement wires.

4. The tire of claim 1 wherein the second triangular shaped bead has a first end forming a base and a second end forming a tip, wherein the base is positioned radially outward of the tip.

5. The tire of claim 1 wherein the second triangular shaped bead is formed of two or more layers of reinforcement wires.

6. The tire of claim 1 wherein the second triangular shaped bead is formed of three or more layers of reinforcement wires.

7. The tire of claim 1 wherein the first triangular shaped bead has a radially outer end that is radially inward of the base of the second triangular shaped bead.

8. The tire of claim 1 further comprising an apex, wherein the apex is formed of a stiff material having a having a shear storage modulus G′ measured at 1% strain and 100° C. according to ASTM D5289 ranging from 23 to 43 MPa.

9. The tire of claim 1 wherein the first or second triangular shaped bead is formed from bead wires having a minimum elongation at break of 6%, as measured by ASTM D4975-14.
